(19) United States
(12) Patent Application Publication
(10) Pub. No.: US 2006/0064667 A1
(43) Pub. Date: Mar. 23, 2006

(54) System and method of model-driven development using a transformation model

(76) Inventor: Jose de Freitas, Markham (CA)

Correspondence Address: DIMOCK STRATTON LLP, 20 QUEEN STREET WEST SUITE 3202, BOX 102, TORONTO, ON, M5H 3R3, CA

(21) Appl. No.: 10/944,221

(22) Filed: Sep. 20, 2004

(51) Int. Cl. G06F 9/44

(52) U.S. Cl. 717/104; 717/106

(57) ABSTRACT

A system and method for model-driven development reduces the complexity of graphical models and permits the generation of code from both UML models and XML schemas. An intermediate model builder engine generates a standardized, intermediate model for input to a transformation model builder engine and creates a transformation model comprising a hierarchy of zero or more domains, technical categories, transformer element sets, transformer elements, and transformation model elements correlating transformers with elements of the intermediate model. A transformation engine uses the transformation model to carry out model transformations, and an output generation engine receives the output of the transformation engine to generate source code or other output.

### FIELD OF THE INVENTION

The present invention relates to model-driven software development, and specifically to a method for generating output from an originating model or schema.

### BACKGROUND OF THE INVENTION

Model-driven development is a method of developing computer software applications based on graphical models. In model-driven development, a specification often comprises a platform-independent model (PIM) created using a graphical modeling language, one or more platform-specific models (PSM) and interface definitions sets to describe how the platform-independent model may be deployed on different middleware platforms such as J2EE or .NET, as well as a full implementation of the specification on each supported software platform. In simple terms, models consist of diagrams that represent, in a concise way, the data and the behaviour of application systems. A graphical modeling language such as Unified Modeling Language (UML™) provides a formal context to these diagrams. For systems that follow the Object Oriented (OO) paradigm, the most widely used type of diagram is the class diagram. Class diagrams consist of classes (templates that describe encapsulated data and behaviour), their respective attributes (data) and methods (behaviour), as well as the associations to other classes.

The Object Management Group (OMG) has developed a standard for model-driven architecture, MDA™ that defines and manipulates models in a standard fashion. MDA employs a UML model and a Meta-Object Facility (MOF), which is a meta-meta-model defining the UML and other modeling idioms, and further employs an XML Metadata Interchange (XMI) that enables different vendors' modeling tools to export and import each other's models. MDA thus provides the benefit of standardization of the model-driven development process.

However, in practice, large systems driven by complex software applications require in turn large, complex models that are developed by teams rather than by individual programmers. Consequently, the modeling tools must be able to support concurrent development of graphical models and provide model merging capabilities, while at the same time ensuring that the integrity of the base model is maintained. This is not a trivial problem, and existing commercial UML modeling tools do not satisfactorily deal with these issues. Furthermore, the use of many related graphical models, including analysis models (“business only” representation of systems objects, relationships and processes), PIMs and PSMS, further compounds the difficulty of preserving the integrity of the underlying platform-independent model. Changes effected in one model must be propagated to other models, and failure to propagate all changes often results in outdated models that are inadequate to use as a reference to write code and/or to generate code. Also, defects or bugs in graphical models are more difficult to detect and diagnose than their counterparts in source code.

For model-driven development, and MDA in particular, to realize its full potential, the modeling tools used in development would preferably provide mechanisms for the partial or complete transformation of graphical models into source code. Many UML modeling tools provide code-generation capabilities, ranging from template-based generation to monolithic generators (i.e., one large, non-modular program usually written in a scripting language).

Although useful, most code generation mechanisms and methods of code generation are limited in their capabilities. Monolithic generators are difficult to maintain and customize, whereas modular, template-driven code generators are often attached to model elements in a restrictive manner. For example, generators may be attached to methods instead of to classes, with the consequence that method signatures (the input and output parameters of the method) must be included in the PIM rather than generated by the code generator. Alternatively, code generators may not be capable of being attached to user-defined groups of model elements.

Furthermore, code generators are typically attached to graphical model entities, which makes the generators modeling-tool specific, since most UML tools do not use a standard UML meta-model (a model that defines UML models, such as the MOF) with common APIs (Application Programming Interfaces) in order to generate source code.

Many generators also require that a class be modeled before it can be generated, which contributes to model complexity and prevents classes from being automatically derived by code generators. Generators also may use scripting languages that do not have adequate syntax checking and debugging capabilities. Most generators further provide little flexibility in defining output targets and customizing the behaviour of the generator with regards to the merging of generated output with existing code.

In addition, there are other important sources of metadata that may be used to develop output code from an underlying model. In particular, XML schemas, which define the structure and semantics of XML (eXtensible Markup Language) documents, are increasingly being used to represent the structure of many emerging XML messaging standards.

It is therefore desirable to provide a system and method for generating code from a platform-independent model that may be used for both UML models and XML schemas while preserving the integrity of the underlying model and facilitating the generation of code. It is further desirable to provide a system and method for model-driven development that reduces model complexity while facilitating the generation of code.

### SUMMARY OF THE INVENTION

The present invention provides a system and method of model-driven development that reduces the use of graphical implementation models, such as PSMs, and of graphical representation of recurring designs, thus reducing model complexity. Rather, metadata transformers associated with metadata elements are used to generate recurring patterns and implementation constructs using a transformation model and a transformation engine. The present invention further comprises a system and method for model-driven development using a non-graphical intermediate model as a common format for representing UML models and other metadata such as XML schema for code generation. Furthermore, the present invention separates metadata transformation from output file generation through the use of an output generation engine and customizable output generators.

Thus, an aspect of the invention provides a system for generating source code from an originating model or schema, comprising an intermediate model builder engine for receiving an originating model or schema and generating a standardized representation of the model or schema, the standardized representation comprising a minimum set of intermediate model elements; a transformation model builder engine for receiving the standardized representation and generating a transformation model comprising at least one transformation model element associated with at least one of the intermediate model elements and with at least one transformer; a transformation engine for executing transformers associated with a selected transformation model element to generate transformation output; and an output generation engine for receiving the transformation output and generating source code. In a further aspect of the invention, the at least one transformation model element is grouped into at least one technical category and is associated with at least one transformer by a transformer element comprising zero or more parameters, and at least one transformer is associated with the at least one technical category. In another aspect of the invention, the transformation engine is further configured to execute transformers associated with a selected one of the at least one technical category, and to execute transformers associated with a selected one of the at least one technical category only if no transformer is associated with a transformation model element that is grouped into said technical category.

Another aspect of the invention provides a method for generating source code from an originating model or schema, the originating model or schema comprising elements, comprising the steps of: generating a transformation model from an originating model or schema for defining the structure of source code to be generated from the originating model or schema, the transformation model comprising at least one technical category comprising zero or more transformation model elements, each transformation model element corresponding to at least one element of the originating model or schema, at least one of each technical category or transformation model element being associated to zero or more transformers; if a selected transformation model element from the zero or more transformation model elements is associated with at least one transformer, running the at least one associated transformer with the selected transformation model element to create transformation output; if a selected transformation model element from the zero or more transformation model elements is not associated with at least one transformer, running the at least one transformer associated with the technical category corresponding to the selected transformation model element, with the selected transformation model element to create transformation output; and passing the transformation output to an output generator to generate the source code. In a further aspect, the invention further provides that the step of generating a transformation model comprises the steps of generating an intermediate model comprising at least one intermediate model element from the originating model or schema, and iterating through the intermediate model to create a transformation model comprising at least one transformation model element corresponding to at least one intermediate model element.

An aspect of the invention further provides a method for generating source code from an originating model or schema, the originating model or schema comprising elements defining the structure of source code to be generated, comprising the steps of: generating an intermediate model from an originating model or schema, the intermediate model comprising at least a minimum set of intermediate elements corresponding to elements of the originating model or schema; generating a transformation model from the intermediate model, the transformation model comprising a set of transformation model elements associated with the set of intermediate elements; transforming at least a selected one of the set of transformation model elements in accordance with a set of pre-defined parameters to produce transformation output; and generating source code using the transformation output.

A further aspect of the invention provides a method for generating source code from an originating model or schema, the originating model or schema comprising elements defining the structure of source code to be generated, comprising the steps of: generating an intermediate model from an originating model or schema, the intermediate model comprising at least a minimum set of intermediate elements corresponding to elements of the originating model or schema; generating a transformation model from the intermediate model the transformation model comprising at least one transformation model element to correspond with the set of intermediate elements; transforming at least one transformation model element in accordance with a set of pre-defined parameters to produce transformation output; and generating source code using the transformation output.

### BRIEF DESCRIPTION OF THE DRAWINGS

In drawings which illustrate by way of example only a preferred embodiment of the invention,

FIG. 1 is a flowchart representation of a method of generating code from a UML model or XML schema;

FIG. 2 is a schematic representation of a system for carrying out the method of FIG. 1;

FIG. 3 is a schematic representation of a preferred embodiment of a transformation model;

FIG. 4 is a schematic representation of the properties of nodes in the transformation model of FIG. 3;

FIG. 5 is an example of a class diagram for a technical design in accordance with a preferred embodiment of the invention;

FIG. 6 is an example of a design class diagram for selected entities in accordance with an embodiment of the invention;

FIG. 7 is a hierarchical representation of an intermediate model;

FIG. 8 is a representation of a transformation model derived from the hierarchical representation of FIG. 7;

FIG. 9 is a representation of a customization of the transformation model of FIG. 8;

FIG. 10 is representation of the addition of transformer elements to a set;

FIG. 11 is a representation of the step of selecting output to be generated at a selected domain; and

FIG. 12 is a representation of the step of generating output code.

### DETAILED DESCRIPTION OF THE INVENTION

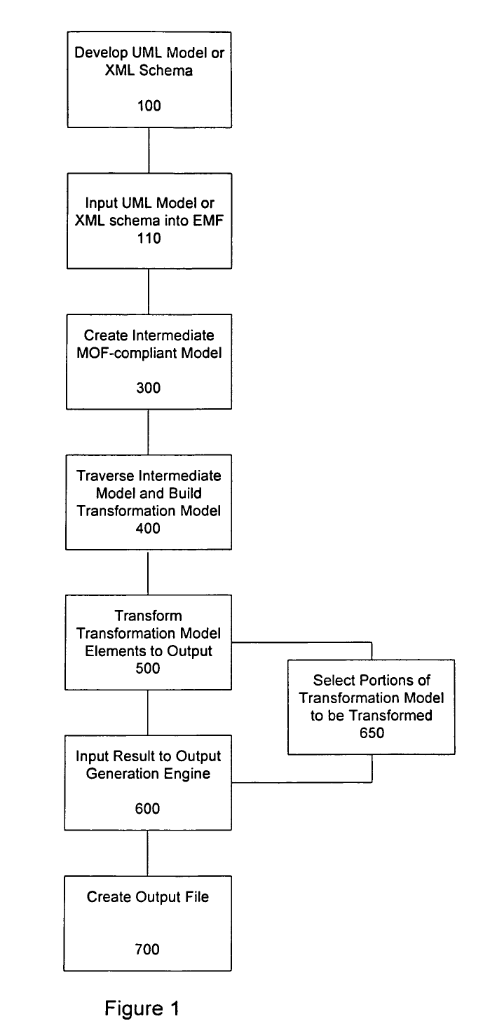

Referring to FIG. 1, an overview flowchart showing a method for code generation from a platform-independent model is shown. A UML model or XML schema is developed 100, representing the processes to be implemented in a software application. For convenience, the description will refer to the UML model, although it will be understood by persons skilled in the art that the description applies likewise to XML schemas. The UML model is input into a meta-object facility (MOF) 110, which creates an intermediate model based on the UML model 300. At step 400, a model builder engine traverses the intermediate model created in step 300 to build a transformation model comprising zero or more model elements. The model elements are then transformed using a transformation engine and transformers to create transformation output 500, which may then be input to an output generation engine at step 600 to create an output file at step 700. Optionally, a user may at step 650 select which portions of the transformation model are to be transformed in step 500 to produce transformation output.

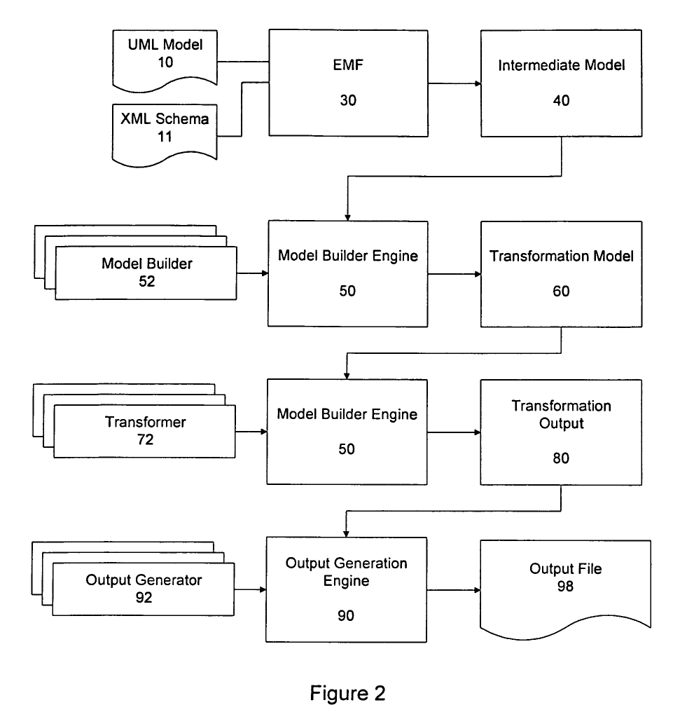

Turning to FIG. 2, a schematic representing a system for generating code from a UML model 10 or XML schema 11 is shown. The model 10 or schema 11 is generated using a modelling tool, such as Rational Rose™ or an annotated Java interface. It will be appreciated that any commercially available tool for modelling software processes may be used, provided the tool complies with OMG standards for model-driven development. The model thus generated will typically comprise a class diagram consisting of classes, attributes, methods and associations. Those skilled in the art will recognize that an XML schema will similarly comprise a class diagram.

A Meta-Object Facility 30 is provided, such as the Eclipse Modeling Framework (EMF). A MOF implementation such as EMF is preferable as it has facilities for importing models generated using Rational Rose™, XML schemas, and annotated Java interfaces as well as other EMF-based models. The MOF 30 is used to produce a non-graphical intermediate model 40, which is a standardized or common representation of the underlying UML model 10 or XML schema 11. While the intermediate model 40 provides a common representation for models 10 or schemas 11 produced using different modelling tools, the intermediate model 40 does not allow for the organization of its constituent model elements into implementation-specific structures, and it further does not allow for the association of transformers with the constituent elements of the intermediate model 40. The intermediate model 40 itself, being a standardized representation of the underlying model 10 or schema 11, is not intended to be edited or extended.

A transformation model builder engine 50 receives input in the form of the intermediate model 40 to generate a transformation model 60. The transformation model 60 is a non-graphical representation of how transformations are to be realized; it defines the structure of the applications to be created, their modules, the target source directories and the packages (in Java, a package maps to a physical directory and is part of the class name-space). The transformation model 60 comprises a hierarchical structure of transformation model elements, each of which comprises a link to a corresponding intermediate model element In its most simple incarnation the transformation model 60 is merely a list of transformation model elements, each of which is linked to an intermediate model element. However, not all intermediate model elements are required to have representation in the transformation model 60; only the minimum set of elements from the intermediate model 40 that is required to provide access to all other model elements, associations and properties is necessary. Preferably, at a minimum the transformation model has links to all classifier elements of the intermediate model 40 (all EClassifier elements if the intermediate model 40 is generated using EMF).

The transformation model builder engine 50 loads and runs a model builder class 52 to which the model builder engine 50 passes a root node for a new model and the file containing the intermediate model. In a preferred embodiment, any manual changes that may have been effected on a previous transformation model 60 generated from the same intermediate model 40 are preserved; in that case, the transformation model builder engine 50 also passes to the default model builder class 52 the previous transformation model. In the preferred embodiment, a previous transformation model 60 may be identified if both the previous and the new transformation model are given the same file name. Preferably, the transformation model builder engine 50 is provided with a default model builder class 52 with a merging mechanism that enables the preservation of model customizations upon re-generation (i.e., subsequent generation of a model). In a preferred embodiment, the default builder class is implemented with the interface set out in Appendix 1.

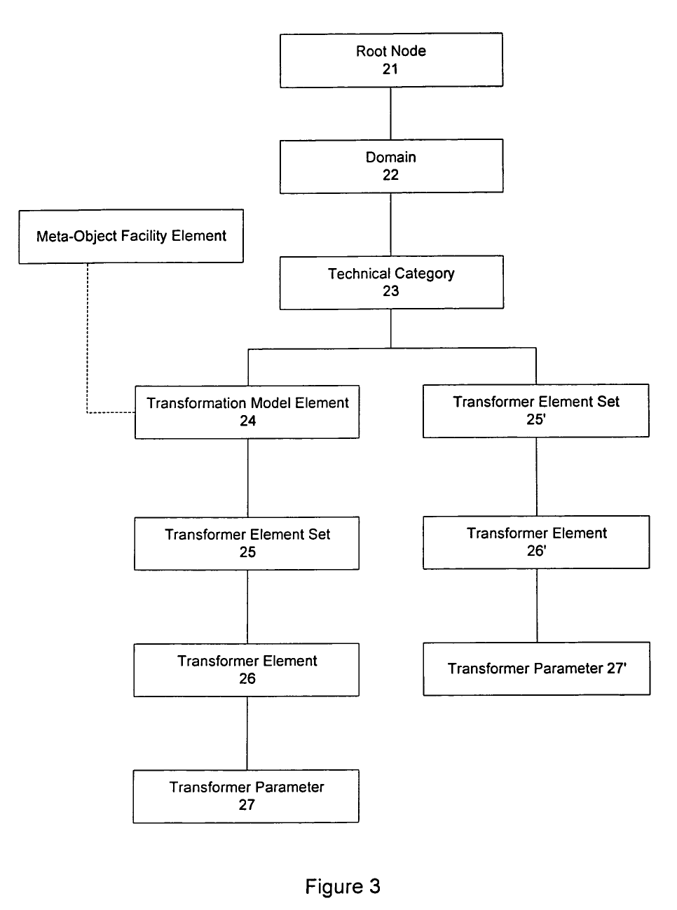

The transformation model builder engine 50 iterates through the intermediate model 40 in order to create transformation model elements 24, as described with reference to FIG. 3 below, and to assign them to default domains and categories. The transformation model builder engine 50 may load and run other model builder classes, provided that they implement the same interface as the default model builder class. Thus, domains 22 and technical categories 23 (described below) may be automatically created based on naming standards or any other assumptions specific to a particular organization.

The transformation model 60 does not comprise implementation classes or designs, but it is customizable by a user. The transformation model 60 is preferably defined by a series of hierarchical nodes, as illustrated in FIG. 3. A root node 21 represents the entire transformation model 60. Beneath the root node 21 are zero or more domains 22, each of which may represent an application (such as branch sales or teller, in the context of a banking system) or a module or part of an application (such as customer maintenance or customer accounts).

Beneath each domain 22 are zero or more element categories or technical categories 23. Element or technical categories 23 are typically used to represent sections of a programming model, for example user interface elements, control objects (service or process classes, such as Funds Transfer or Deposit), entity objects (such as Customer or Account), or web services (packages of functions, such as sets of financial transactions). Each technical category 23 comprises zero or more transformation model elements 24, as well as zero or more transformer element sets 25′.

A transformation model element 24 has a link to a model element in the intermediate model 60, thus providing access to the intermediate model element's properties and relationships. A transformation model element 24 also has zero or more transformer element sets 25 associated with it. A transformer element set 25, 25′ is a grouping of zero or more transformer elements 26, 26′, and is a convenience structure to facilitate the management of multiple transformer elements 26, 26′ as a group. Each transformer element 26, 26′ is associated with zero or more transformer parameters 27, 27′, which are preferably key-value pairs that are passed to transformers 72 associated with the transformer elements 26, 26′. These transformers 72 are loaded and run by the transformation engine 70. The transformation parameters 27, 27′ are used to configure the behaviour of the associated transformer. Preferably, any number of user-defined parameters 27, 27′ may be associated with the transformer elements 26, 26′.

The transformer element 26, 26′ further comprises the transformer classes for a particular platform. Accordingly, if the model is intended to be deployed in a different environment, it is not necessary to restructure the underlying model 10, 11, or intermediate model 40; it is merely necessary to alter the transformer classes and/or the transformer parameters 27, 27′.

By organizing the various nodes (root node 21, domain 22, technical category 23, transformer set 25, 25′) in this manner, the management and organization of the transformation model 60 is facilitated. For example, an entire group of transformer elements 26, 26′ may be disabled or copied to another technical category 23 by operating on the transformer set 25, 25′. Also, by allocating transformer elements 26′ by technical category 23 as well as by model element 24, it is not necessary to specify transformers 72 for every model element within the category 23. The domain node 22 may further be customized to specify into what package or project the transformation output is to be generated. Furthermore, this transformation model structure 60 allows the user to defer application organization to a later stage in the software development cycle. The original graphical model 10 or XML schema 11 need not be constructed with concern for the ultimate organization of the application.

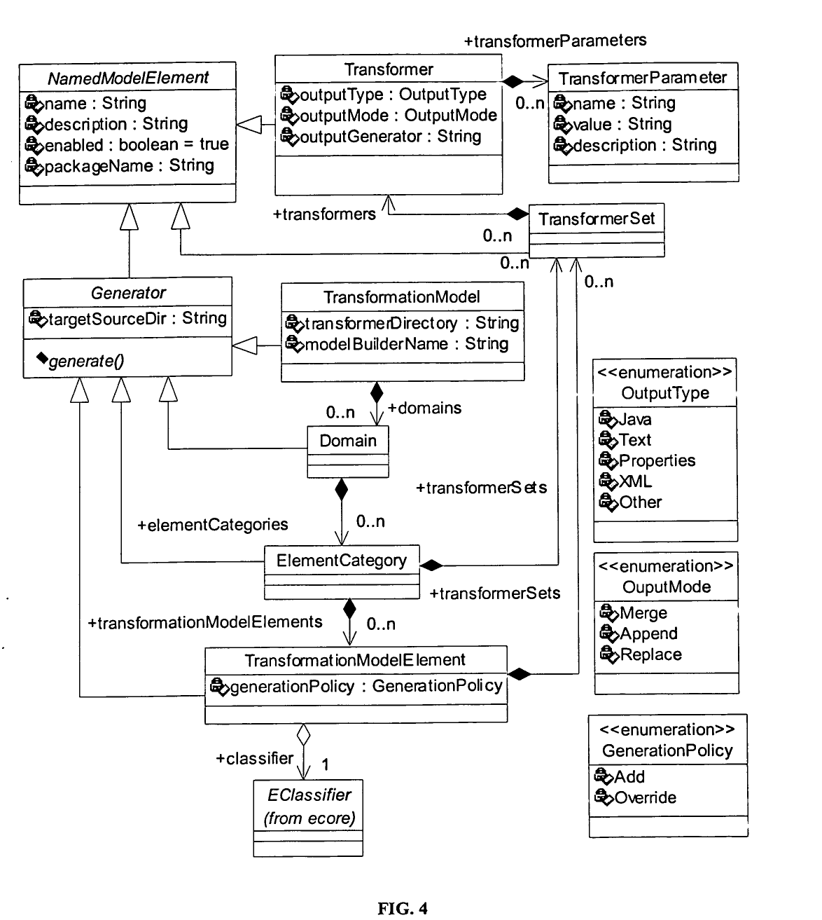

Each node 21, 22, 23, 24 of the transformation model 60 is further provided with properties that define whether or not a node is enabled for transformation, the type of output to be generated, and the generation policy. The properties are illustrated in FIG. 4.

If manual changes were made to a previous UML model 10 from which an intermediate model 40 had been previously generated, these changes may be incorporated when a subsequent transformation model is generated from intermediate model 40 that is regenerated from the changed UML model 10. When the new transformation model is generated, the previous transformation model and the intermediate model 40 are traversed at the same time. All classifier elements from the intermediate model 40 are incorporated into the new transformation model but before doing this the transformation model builder engine 50 checks the previous transformation model to see if a like-named element exists. If it does, the transformation model builder engine 50 identifies the category of the like-named element in the previous transformation model, and identifies what transformers are associated it. The model builder engine 50 then creates the category (and the domain to which the category belongs, if the category and domain do not yet exist) and the transformer elements in the new transformation model 60.

A transformation engine 70 is provided for transforming the transformation model 60 to transformation output 80. The transformation engine 70 loads and runs transformers 72, which are executable modules of code. Through the transformer elements 26, 26′ of the transformation model 60, the transformers 72 are thus associated with specific model elements 24 or categories 23, with access to all other related elements. By associating the transformers 72 with the transformer elements 26, 26′ and their parameters 27, 27′ in this manner, it is possible for the transformers 72 to derive related classes from a single model element 24. Preferably, the transformers 72 are written in a powerful, all-purpose language such as Java, which enables the use of syntax checking and debugging capabilities. Java is also a preferred language since it allows for economy in transformer design and the use of inheritance to increase the re-use potential of the transformers. Transformers may be provided by vendors, or they may be created or customized by organizations to meet specific requirements.

A user may optionally select one or more nodes 22, 23, 24 from the transformation model 60 to be transformed, or else the entire transformation model 60, via automatic selection of the root node 21, may be transformed using the engine 70. The transformation engine 70 then traverses the selected node(s) in accordance with the following method:

If the node is an enabled transformation model element 24, then the transformation engine 70 loads and runs all the enabled transformers 72 associated with that element 24 through the associated transformer element 26. If there are no associated transformer elements 26, the transformation engine 70 looks for transformer elements 26′ associated with the transformation model element's immediate ancestor (a technical category node 23) and runs those transformers 72 associated with the transformer elements 26′. The transformation engine 70 also passes the transformer parameters 27 or 27′ associated with each transformer element 26 or 26′ to the transformer instance created the transformation engine 70. Preferably, the transformation model element 24 has a property that indicates to the transformation engine 70 whether it should also run the transformers 72 for the transformation model element's category 23 (ADD), or override the category's transformers 26′ (OVERRIDE).

If the node is a transformation model root node 21, a domain node 22 or technical category node 23, the transformation engine 70 traverses the enabled node and all its enabled descendants and transforms each transformation model element 24 that it finds in the manner described above.

The output of each transformation 80 produced by the transformation engine 70 is then passed to the output generation engine 90 for generating an output file 98.

In a preferred embodiment, a transformer 72 may be debugged by a Java debugger executed in collaboration with the transformation engine 70, to enable step-by-step debugging of the transformer 72.

The output generation engine 90 receives the transformation output 80, and loads and executes any instance of a class implementing an output generator interface. Referring to Appendix 1, a preferred interface is the OutputGenerator interface. In this manner, the model transformation steps are separated from the output generation process, thus allowing for different generation policies for the same transformations (for example, appending, replacing or merging) and to permit very specific output generation requirements (such as the merging of Java source code or the updating of specialized XML configuration files).

In the preferred embodiment, default output generators 92 are provided for merging Java source code, generating and appending to text files, and generating and merging Java properties files.

Without the use of the transformation model 60, the complexity of the underlying model UML model 10 and intermediate model 40 would be increased, as these models would be required to contain additional classes and/or implementation details that are inherently provided in the structure of the transformation model 60 and its associated transformers. Recurring constructs, such as object factories and data access patterns can be generated by the transformers, further contributing to the simplification of the original model. More importantly, the transformation model provides the basis for managing and executing model transformations with a level of ease and flexibility that would otherwise not be possible.

A typical, simplified usage scenario of the above system and method of code generation is now described.

Bank A wishes to develop a new application system to manage its customers and their accounts. After gathering requirements and creating analysis models, a design must be established. An important aspect of the design is the development of the application's entity objects. Entity objects are persistent objects that hold the data and provide encapsulated behaviour for the system. They are typically the most stable and reusable components of an application system.

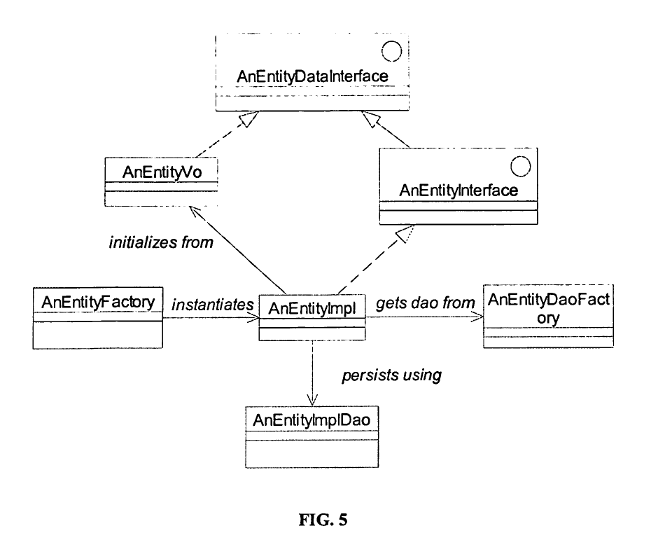

In this scenario, it is determined that the implementation of entity objects may be subject to future changes. Because of this, it is required that each entity object be represented by an interface. For the same reason, a factory class is required to create the implementation object. It is also determined that the entity object data may be sent over a network, therefore a value object is also required. Finally, because the entity object may be persisted to a local relational database in some cases and in other cases it is sent to the host system to be persisted there, it is decided that different data access objects would be used to carry out data management operations. The simplified class diagram for this technical design is shown in FIG. 5.

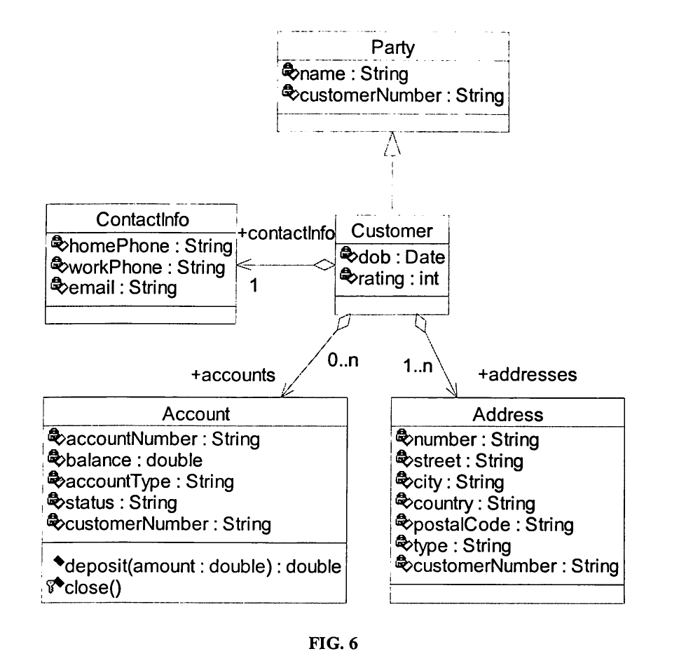

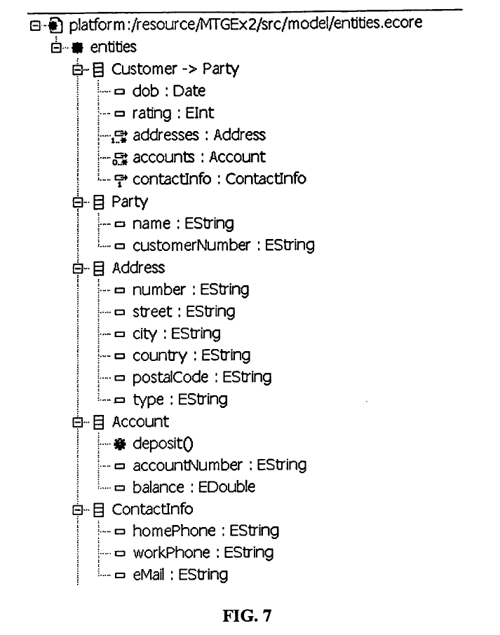

In the method described above, a design class diagram is created for Party, Customer, ContactInfo, Address and Account entities (FIG. 6) without concern for implementation details, focusing only on the business objects and their respective properties, methods and relationships, using UML. Interfaces, factories, other technical objects, and get and set methods are not added to the entity classes because this method allows for the automatic generation of these patterns via the transformer elements 26, 26′ and transformers 72. The UML model is then imported into EMF to create an intermediate model, the hierarchical representation of which is shown in FIG. 7.

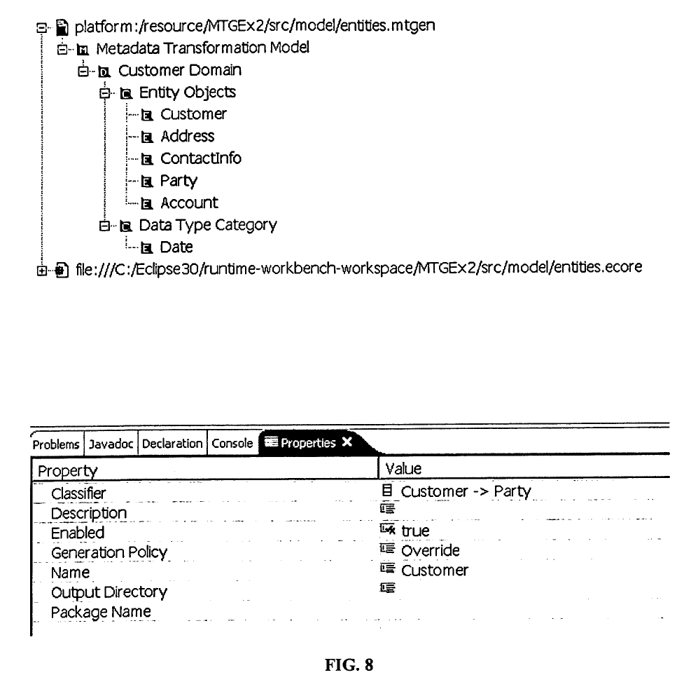

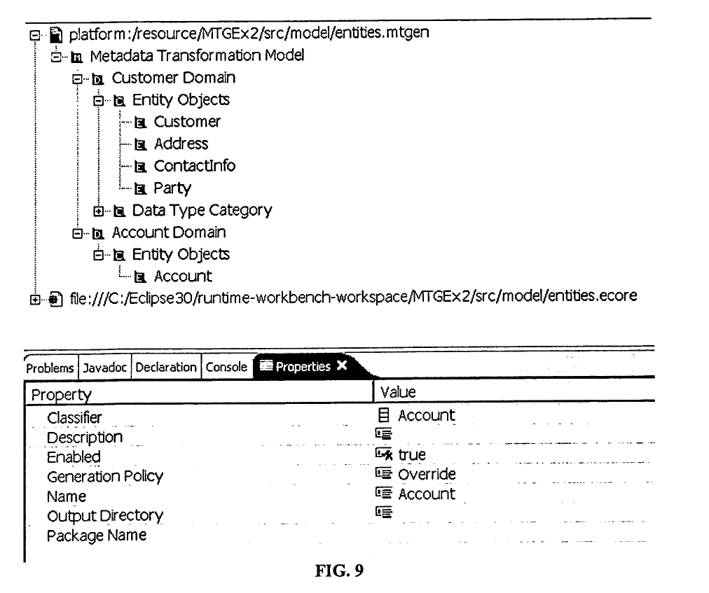

A transformation model is then created from the intermediate model, using the default builder class, to create the transformation model shown in FIG. 8. The transformation model may then be customized. In this scenario, the Customer entity and its dependent classes are handled and packaged separately from the Account entity. Accordingly, separate Customer and Account domains are created and the Account element is moved to the Account domain (FIG. 9).

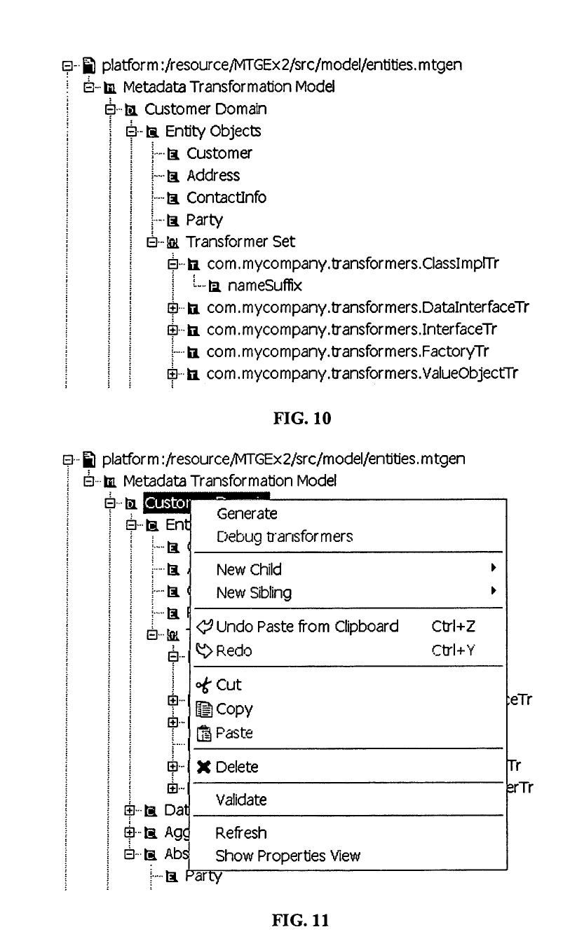

Transformer elements are added to the transformation model. The transformer elements may be associated with pre-existing transformers, or new transformers may be created. Each transformer element is given the name of a transformer, as shown in FIG. 10. The transformer elements are added to a transformer set and the set is assigned to the entity categories. There is no need to assign transformers to individual elements, since each entity object follows exactly the same design pattern.

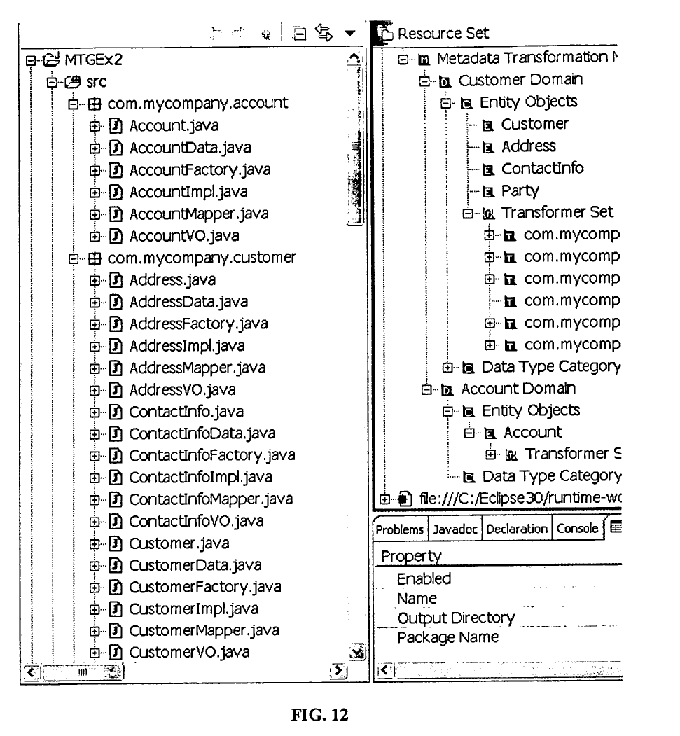

Output, in this case Java code, is generated. As shown in FIG. 11, the code is generated at the Customer domain level, although it could be generated at any other node level. Java files are created, as shown in FIG. 12; the output generator takes care of merging and code preservation requirements.

If the original UML model needs to be changed, the UML model is re-imported into the EMF. The default model builder preserves the structure of the existing model, adds any new elements and removes those that have been deleted. Selective re-generation of the changed elements will result in new versions of the Java source code.

Various embodiments of the present invention having been thus described in detail by way of example, it will be apparent to those skilled in the art that variations and modifications may be made without departing from the invention. The invention includes all such variations and modifications that fall within the scope of the appended claims.

### Appendix 1

com.patternset.mtgen.model

Interface ModelBuilder

public interface ModelBuilder

The ModelBuilder interface is implemented by all model builder classes. Custom model builders may be written to automatically define the structure of the generated model.

Method Detail

| | Method Summary |
|---|---|
| void | buildGenModel(TransformationModel genModel, |
| | org.eclipse.emf.ecore.resource.Resource resource, |
| | TransformationModel oldModel) |
| | Creates a Transformation/Generation model(MTG model). |

buildGenModel
public void buildGenModel(TransformationModel genModel, org.eclipse.emf.ecore.resource.Resource resource, TransformationModel oldModel)

Creates a Transformation/Generation model (MTG model). The new MTG model is created by iterating through the input EMF model and creating transformation model elements corresponding to each EClassifier element that is encountered.

Parameters:

genModel—The root of the new MTG (transformation) model

resource—The EMF resource corresponding to the input model.

oldModel—An existing MTG model with the same name as the new model or null if it does not exist.

com.patternset.mtgen.transform

Interface Transformer

public interface Transformer

Transformer is the interface that all transformers must implement

| | Method Summary |
|---|---|
| Transformer | transform(TransformationModelElement transformerInput, |
| Result | java.util.Map transformerParameters) |
| | Implementors of Transformer must implement the transform |
| | method. |

Method Detail
transform
public TransformerResult transform(TransformationModelElement transformerInput, java.util.Map transformerParameters)

Implementors of Transformer must implement the transform method. This method is invoked by the Transformation Engine to carry out the transformation.

Parameters:

transformerInput—Typically a model element that is passed as input to the transformer.

transformerParameters—A map containing all the transformer parameters.

Returns:

TransformerResult The result of the transformation

com.patternset.mtgen.engine

Interface OutputGenerator

public interface OutputGenerator

This is the interface that all output generators have to implement.

| | Method Summary |
|---|---|
| void | writeFile(TransformerResult transformerResult, |
| | org.eclipse.core.runtime.IProgressMonitor progressMonitor) |
| | Users of the OutputGenarator interface must implement the |
| | writeFile method. |

Method Detail
writeFile
public void writeFile(TransformerResult transformerResult, org.eclipse.core.runtime.IProgressMonitor progressMonitor)

throws MTGException

Users of the OutputGenarator interface must implement the writeFile method. Typically, within the body of this method, the contents of the transformation result are written to a new file, or appended or merged to an existing file.

Parameters:

transformerResult—the result of the transformation

progressMonitor—an eclipse progress monitor

Throws:

MTGException

MTGException is the type of Java exception (error) that is thrown when an error is encountered

See Also:

TransformerResult

What is claimed is:

1. A system for generating source code from an originating model or schema, comprising:
an intermediate model builder engine for receiving an originating model or schema and generating a standardized representation of the model or schema, the standardized representation comprising a minimum set of intermediate model elements;
a transformation model builder engine for receiving the standardized representation and generating a transformation model comprising at least one transformation model element associated with at least one of the intermediate model elements and with at least one transformer;
a transformation engine for executing transformers associated with a selected transformation model element to generate transformation output;
an output generation engine for receiving the transformation output and generating source code.

2. The system of claim 1 wherein the at least one transformation model element is grouped into at least one technical category.

3. The system of claim 1 wherein the at least one transformation model element is associated with at least one transformer by a transformer element comprising zero or more parameters.

4. The system of claim 3 wherein the at least one transformer elements is grouped into at least one set of transformer elements.

5. The system of claim 3 wherein at least one transformer is associated with the at least one technical category.

6. The system of claim 5 wherein the at least one technical category is grouped into at least one domain.

7. The system of claim 5 wherein the transformation engine is further configured to execute transformers associated with a selected one of the at least one technical category.

8. The system of claim 5 wherein the transformation engine is further configured to execute transformers associated with a selected one of the at least one technical category only if no transformer is associated with a transformation model element that is grouped into said technical category.

9. A method for generating source code from an originating model or schema, the originating model or schema comprising elements, comprising the steps of:
generating a transformation model from an originating model or schema for defining the structure of source code to be generated from the originating model or schema, the transformation model comprising:
at least one technical category comprising zero or more transformation model elements, each transformation model element corresponding to at least one element of the originating model or schema, at least one of each technical category or transformation model element being associated to zero or more transformers;
if a selected transformation model element from the zero or more transformation model elements is associated with at least one transformer, running the at least one associated transformer with the selected transformation model element to create transformation output;
if a selected transformation model element from the zero or more transformation model elements is not associated with at least one transformer, running the at least one transformer associated with the technical category corresponding to the selected transformation model element, with the selected transformation model element to create transformation output;
passing the transformation output to an output generator to generate the source code.

10. The method of claim 9 wherein the step of generating a transformation model comprises the steps of generating an intermediate model comprising at least one intermediate model element from the originating model or schema, and iterating through the intermediate module to create a transformation model comprising at least one transformation model element corresponding to at least one intermediate model element.

11. The method of claim 10 wherein the transformation model comprises a hierarchy of at least one hierarchical element selected from the set of transformation model root elements, domains, technical categories, and transformation model elements.

12. The method of claim 11 wherein the step of generating a transformation model further comprises the step of associating the at least one technical category or transformation model element with zero or more transformers using zero or more transformer elements.

13. A method for generating source code from an originating model or schema, the originating model or schema comprising elements defining the structure of source code to be generated, comprising the steps of:
generating an intermediate model from an originating model or schema, the intermediate model comprising at least a minimum set of intermediate elements corresponding to elements of the originating model or schema;
generating a transformation model from the intermediate model, the transformation model comprising a set of transformation model elements associated with the set of intermediate elements;
transforming at least a selected one of the set of transformation model elements in accordance with a set of pre-defined parameters to produce transformation output; and
generating source code using the transformation output.

14. The method of claim 13 wherein the step of generating a transformation model further comprises the step of grouping at least a subset of the set of transformation model elements within at least one domain.

15. The method of claim 13 wherein the step of generating a transformation model further comprises the step of grouping at least a subset of the set of transformation model elements within at least one technical category.

16. The method of claim 15 wherein the step of generating a transformation model further comprises the step of grouping at least one technical category within a domain.

17. The method of claim 15 wherein the step of transforming at least a selected one of the set of transformation model elements comprises the step of transforming the transformation model elements grouped within a selected one of the at least one technical category in accordance with a set of pre-defined parameters associated with the said transformation model elements to produce transformation output.

18. The method of claim 17 wherein the step of transforming at least a selected one of the set of transformation model elements further comprises the step of transforming the transformation model elements grouped within a selected one of the at least one technical category in accordance with a set of pre-defined parameters associated with the selected one of the at least one technical category to produce transformation output.

19. The method of claim 18 wherein the step of transforming the transformation model elements grouped within a selected one of the at least one technical category in accordance with a set of pre-defined parameters associated with the selected one of the at least one technical category is executed only when no pre-defined parameters associated with the said transformation model elements exist.

20. The method of claim 13 further comprising the step of creating an originating model or schema.

21. A method for generating source code from an originating model or schema, the originating model or schema comprising elements defining the structure of source code to be generated, comprising the steps of:
generating an intermediate model from an originating model or schema, the intermediate model comprising at least a minimum set of intermediate elements corresponding to elements of the originating model or schema;
generating a transformation model from the intermediate model, the transformation model comprising at least one transformation model element to correspond with the set of intermediate elements;
transforming at least one transformation model element in accordance with a set of pre-defined parameters to produce transformation output; and
generating source code using the transformation output.

22. The method of claim 21 wherein the step of generating a transformation model further comprises the step of grouping at least one transformation model element within at least one domain.

23. The method of claim 21 wherein the step of generating a transformation model further comprises the step of grouping at least one transformation model element within at least one technical category.

24. The method of claim 23 wherein the step of generating a transformation model further comprises the step of grouping at least one technical category within a domain.

25. The method of claim 23 wherein the step of transforming at least one transformation model element comprises the step of transforming the transformation model elements grouped within at least one technical category in accordance with a set of pre-defined parameters associated with the at least one transformation model element to produce transformation output.

26. The method of claim 25 wherein the step of transforming at least one transformation model element further comprises the step of transforming the transformation model elements grouped within at least one technical category in accordance with a set of pre-defined parameters associated with the technical category to produce transformation output.

27. The method of claim 26 wherein the step of transforming the transformation model elements grouped within the at least one technical category in accordance with a set of pre-defined parameters associated with the technical category is executed only when no pre-defined parameters associated with the said transformation model elements exist.

28. The method of claim 21 further comprising the step of creating an originating model or schema.
